(19) United States
(12) Patent Application Publication
(10) Pub. No.: US 2013/0132859 A1
(43) Pub. Date: May 23, 2013

(54) METHOD AND ELECTRONIC DEVICE FOR COLLABORATIVE EDITING BY PLURALITY OF MOBILE DEVICES

(71) Applicants: Shih-Chun Chou, Taipei City (TW); Bo-Fu Liu, Tainan City (TW); Yu-Ting Lin, Chiayi City (TW); Jih-Yiing Lin, Zhuqi Township (TW)

(72) Inventors: Shih-Chun Chou, Taipei City (TW); Bo-Fu Liu, Tainan City (TW); Yu-Ting Lin, Chiayi City (TW); Jih-Yiing Lin, Zhuqi Township (TW)

(73) Assignee: INSTITUTE FOR INFORMATION INDUSTRY, Taipei (TW)

(21) Appl. No.: 13/316,802

(22) Filed: Dec. 12, 2011

(30) Foreign Application Priority Data
Nov. 18, 2011 (TW) 100142227

(51) Int. Cl. G06F 3/048

(52) U.S. Cl. 715/751

(57) ABSTRACT

A method for collaborative editing by a plurality of mobile devices including communicating with a plurality of mobile devices via a wireless network to receive packets from the mobile devices, respectively, and by the embedded processing unit, decoding the received packets to obtain an editing command for a collaborative editing file, editing the collaborative editing file and generating a display image according the editing command, and transmitting the display image to a display unit to display the display image.

### CROSS REFERENCE TO RELATED APPLICATIONS

This Application claims priority of Taiwan Patent Application No. 100142227, filed on Nov. 18, 2011, the entirety of which is incorporated by reference herein.

### BACKGROUND OF THE INVENTION

1. Field of the Invention

The present invention relates to editing, and in particular relates to collaborative editing by a plurality of mobile devices.

2. Description of the Related Art

In group discussions, frequently it is necessary to share files quickly and simply during a presentation. It is also necessary to instantly edit the content of the presentation stuff during the discussion of a presentation. In a related art, a mobile device, including a display module, a short-range communication module and a controller used for searching at least one device available for short-range communication and displaying the location of the searched device on the display module, is presented for file transmissions between mobile devices.

However, this method emphasizes how to search the device and could only shares files one-by-one. Therefore, a novel design for collaborative editing by a plurality of mobile devices is highly required.

### BRIEF SUMMARY OF THE INVENTION

According to one aspect, an electronic device for collaborative editing by a plurality of mobile devices includes a wireless module communicating with a plurality of mobile devices via a wireless network to receive packets from the mobile devices, respectively, and an embedded processing unit decoding the received packets to obtain an editing command, editing a collaborative editing file according the editing command, generating a display image, and transmitting the display image to a display unit to display the display image.

According to one aspect, a method for collaborative editing by a plurality of mobile devices, is suitable for an electronic device which includes an processing unit and a wireless module. The method includes communicating with a plurality of mobile devices by the wireless module and a wireless network to receive packets from the mobile devices, respectively, and decoding the received packets to obtain an editing command, editing a collaborative editing file according the editing command, generating a display image, and transmitting the display image to a display unit to display the display image by the embedded processing unit.

### BRIEF DESCRIPTION OF THE DRAWINGS

The present invention can be more fully understood by reading the subsequent detailed description and examples with references made to the accompanying drawings, wherein:

FIG. 1a shows a schematic block diagram of an electronic device according to an embodiment of the invention;

FIG. 1b shows a schematic block diagram of an electronic device according to another embodiment of the invention;

FIG. 2a shows a method of configuring the display image when there are three sharing files;

FIG. 2b shows a method of configuring the display image when there are five sharing files;

FIG. 2c shows a method of configuring the display image when there is a sharing file;

FIG. 2d shows a method of configuring the display image when there are two sharing files;

FIG. 3 shows an image configuration according to an embodiment of the invention;

FIG. 4 shows a method of switching display image arrangements according to an embodiment of the invention;

FIG. 5 shows a method of downloading files according to an embodiment of the invention; and

FIG. 6 shows a flow chart of the method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

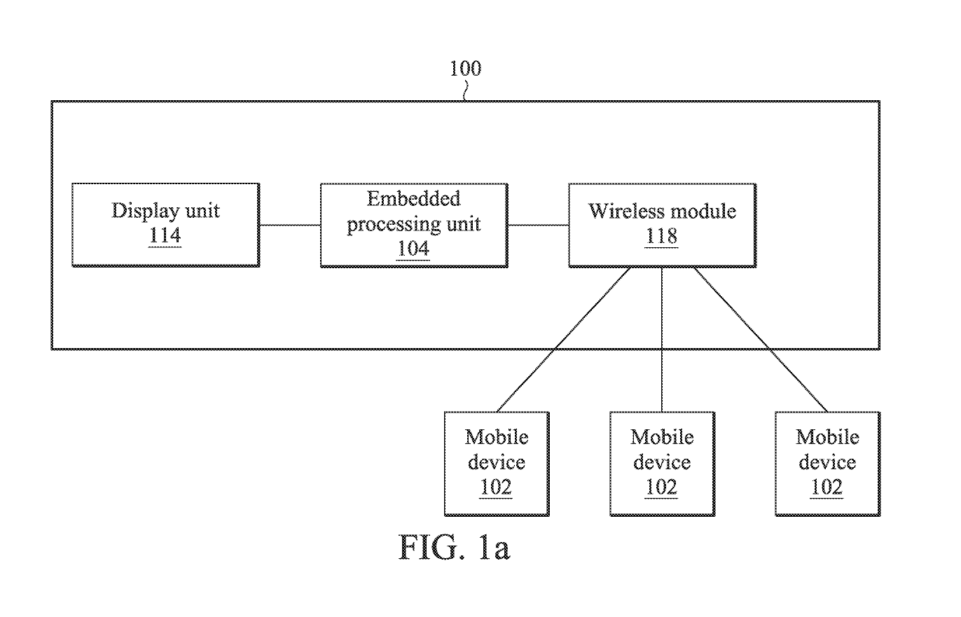

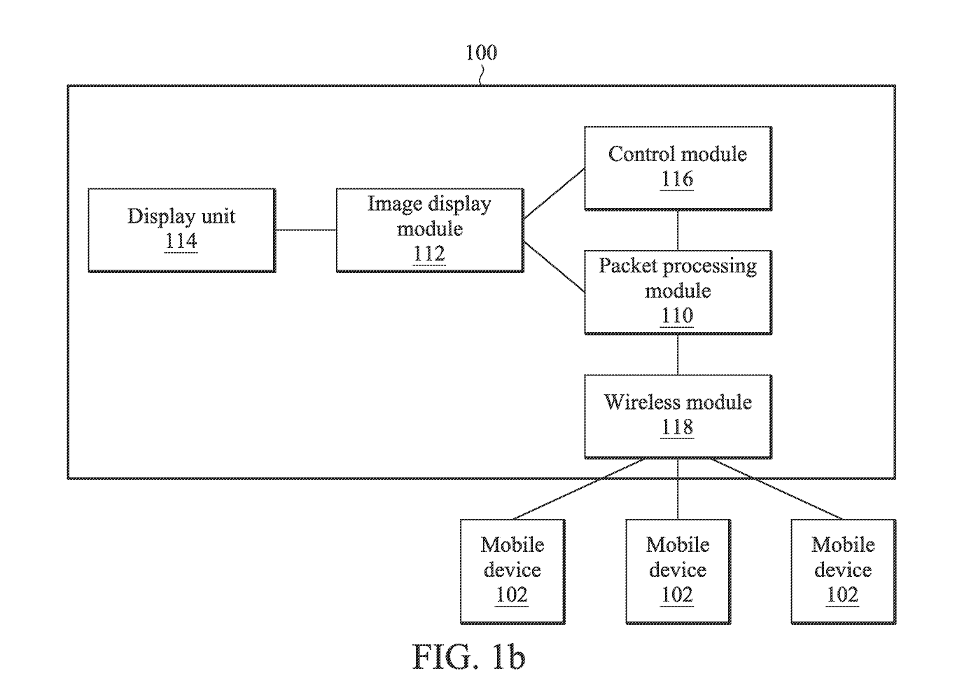

FIG. 1a shows a schematic block diagram of an electronic device according to an embodiment of the invention. As shown in FIG. 1a, the electronic device 100 performs collaborative editing by a plurality of mobile devices. The electronic device 100 may at least comprise an embedded processing unit 104 and a wireless module 118. The wireless module 118 communicates with a plurality of mobile devices 102 via a wireless network, and receives packets from each mobile device 102, respectively. For example, the wireless module 118 is a circuit which may at least comprise signal processing unit, RF, an amplifier, and so on. The wireless module 118 handles the transmitting packets between electronic device 100 and mobile devices 102 via a short-range communication protocol, wherein the short-range communication protocol may be a local area network such as Wi-Fi, Bluetooth, Near Field Communication (NFC), and so on. According to another embodiment of the invention, the communication network which is used by a mobile device may be adopted, wherein the communication network can be 3G, GPRS, GSM, CDMA2000, and so on.

When a collaborative editing file is stored in the embedded processing unit 104, the embedded processing unit 104 decodes the received packets to obtain an editing command, edits the collaborative editing file according to the editing command, generates a display image, and transmits the display image to a display unit 114 to display an image. The embedded processing unit can be processing units such as ARM processors, MIPS processors, PowerPC processors, and so on, but it is not limited thereto.

Further, the electronic device 100 may comprise the display unit 114 to display the display image generated by the embedded processing unit 104. The electronic device 100 may not comprise the display unit 114 but be connected to an external display unit to display the display image. In some embodiments, the electronic device 100 can be a Set-top Box (STB), the display unit 114 can be a TV, and the STB and the TV can be combined into an Internet-enabled TV. The electronic device 100 can be combined with the display unit 114 into a commercial product such as a digital photo frame and a digital TV. In another embodiment, the electronic device 100 can be a projector, and the display unit 114 can be a projection unit of the projector used for projecting the generated display image.

Further as shown in FIG. 1b, the embedded processing unit 104 may comprise a packet processing module 110, an image display module 112 and a control module 116. In another embodiment, the image display module 112 may be set in another processor (for example: a graphic processing unit), and the embedded processing unit 104 only comprises the packet processing module 110 and the control module 116. A graphic processing unit of an image display module 112 is electrically coupled to the embedded processing unit 104 in order to assist the embedded processing unit 104 to generate the display image and transmit the display image to the display unit 114. For example, the packet processing module 110, the image display module 112 and the control module 116 are implemented by software stored in a secondary storage module (ex: hard disk), and are loaded into a primary storage module (ex: internal memory) for the embedded processing unit 104 to read the software and perform related functions. In another embodiment, the packet processing module 110, the image display module 112 and the control module 116 are firmware stored in a read only memory (ROM) or read only memories. The packet processing module 110 decodes the received packets to obtain an editing command, the control module 116 edits a collaborative editing file according to the editing command, and the image display module 112 generates the display image according to the result of the edition. The details of the function are described as follow.

Further, the mobile device 102 may further comprise a file editing module 120 (not shown in FIG. 1b), such as an embedded program and applications installed in mobile devices 102. A user of the mobile device 102 may enable a file processing function by the file editing module 120, wherein the file processing function includes providing the following operations such as split screen arrangement, displaying, transmission, addition, deletion, revision and searching for a first file. For example, users may enable the file processing module 120 by many means (such as double tap, triple tap, long press, voice-control, and so on) to start file processing function as recited above. Then, the file processing module 120 shows a dialog on the display unit of the mobile device 102 in order to provide the user to select/confirm the first file and/or an access permission setting corresponding to the first file and/or an editing command.

And then by the wireless communication module (available for short-range communication) of the mobile devices 102, the file processing module 120 detects if there are electronic devices (electronic device 100) with display devices nearby for communication and collaborative editing. When the file processing module 120 has found an electronic device with a display device and available for short-range communication, the file processing module 120 shows a list on the display device of the mobile device 102 in order to provide the user of the mobile device 102 with selection of a desired electronic device to connect with. Then the file processing module 120 connects with the wireless module 118 of the electronic device 100 by the wireless module of the mobile device 102 and transmits a first file (a file to be shared) and/or an access permission setting corresponding to the first file and/or an editing command to the electronic device 100. If the file processing module 120 has transmitted the first file, the first file can be used as a collaborative editing file.

After the wireless module 118 receives packets of the first file (a file to be shared), the wireless module 118 transmits the packets to the packet processing module 110. The packet processing module 110 decodes the received packets and stores the first file into a storage module (not shown in FIG. 1b). When there is no collaborative editing files in the storage module, the first file can be used as the collaborative editing file shared by a plurality of mobile devices, and when there is a collaborative editing file in the storage module, the file processing module 120 may only transmit an editing command by the mobile device 102 to edit the collaborative editing file. The file processing module 120 may replace the collaborative editing file with the first file, or use the first file as a second collaborative editing file. In some embodiments, the storage module may be embedded in the control module 160 or another component in the electronic device 100.

Further, when a second mobile device (another mobile device) is also connected to the electronic device 100, the embedded processing unit 104 may also receive packets from the second mobile device, decode the received packets to obtain a second file and an editing command, and then edit the second file and the collaborative editing file.

Further, an access permission setting corresponding to the first file is transmitted by the wireless module of mobile device 102 with the first file to the electronic device 100. After the wireless module 118 receives packets of the file, the access permission setting of the first file, and the editing command, the wireless module 118 transmits the packets to packet processing module 110. The packet processing module 110 decodes the received packets to obtain the access permission setting of the file set by the user of the mobile device 102 and stores the first file into the storage module. The packet processing module 110 transmits the file access permission setting to the control module 116. The control module 116 shares and edits the file with other mobile devices which are connected to the wireless module 118 according to the file access permission setting of the mobile device 102. Sharing files means all of the uploaded files (the first file or the collaborative editing file) are stored in the storage module or the control module 116, and all the mobile devices 102 can download, transmit, and edit files from the storage module or the control module 116 according to access permission setting of the file.

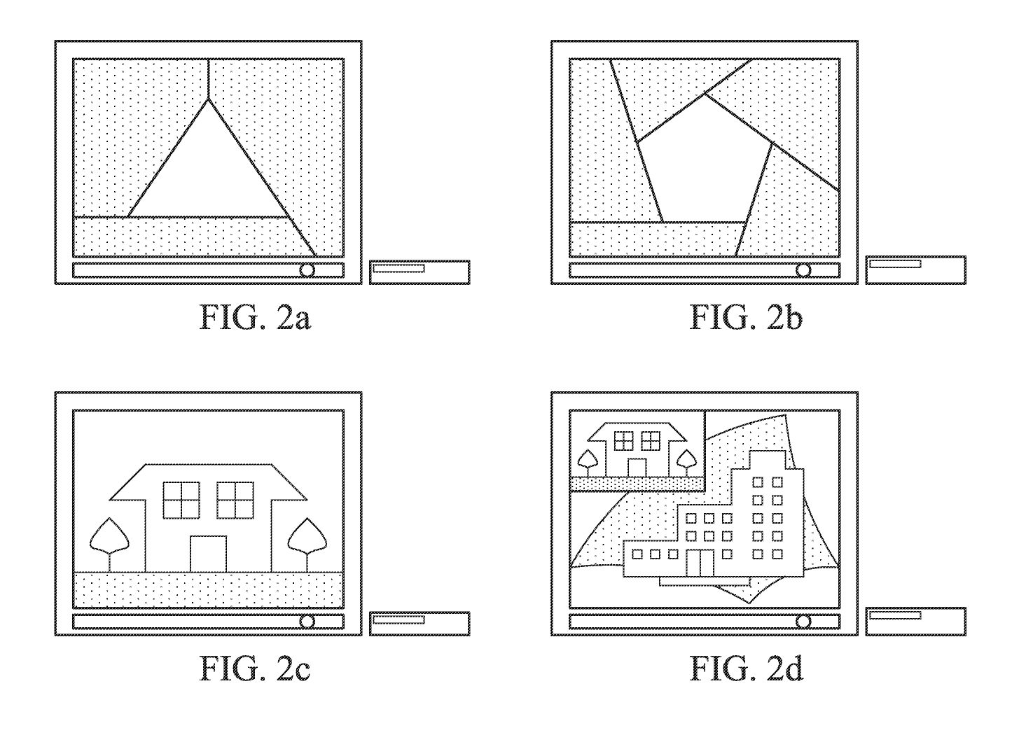

Further, when a plurality of mobile devices transmit sharing files to the electronic device 100, the image display module 112 generates the display image of the display unit 114 according to the number of all the shared files (one of the collaborative editing file, the first file, the second file, . . . , or a combination of the files above). The methods of configuring the display images corresponding to different numbers of shared files are shown in FIGS. 2a-2d. FIG. 2a shows a method of configuring the display image when there are three sharing files. FIG. 2b shows a method of configuring the display image when there are five sharing files. FIG. 2c shows a method of configuring the display image when there is a sharing file. FIG. 2d shows a method of configuring the display image when there are two sharing files.

Then the image display module 112 transmits the display image to the display unit 114 and the wireless module 118. The wireless module 118 transmits the received display image to the mobile device 102 to display a display image on the screen of the mobile device 102. The display unit 114 of the electronic device 100 displays the display image. In one embodiment, the display unit 114 can be a projection unit, the image display module 112 configures the display image which is projected by the projection unit according to the number of all the shared files (files to be displayed) and generates the display image. The projection unit projects a projection image according to the display image.

Further, when a plurality of mobile devices transmit sharing files to the electronic device 100 and select a sharing file from all the sharing files as a collaborative editing file, the mobile devices 102 which are connected to the wireless module 118 are in a collaborative editing mode. The users of all the mobile devices 102 which are in the collaborative editing mode may edit (ex: display, split screen, transmit, add, delete, revise, search, and so on) the collaborative editing file according to the file access permission setting. For example, the packet processing module 110 decodes the received packets from the first mobile device to obtain a first file, wherein the first file may be used as the collaborative editing file. Then the packet processing module 110 decodes the received packets from the second mobile device to obtain a second file, decodes the received packets from the mobile devices (including the first and second mobile device) to obtain editing commands, and transmits the editing commands to the control module 116 in order to let the control module 116 manage the edition of the collaborative editing file and the second file stored in the storage module. For example, the user of the mobile device 102 can paste a second file (a picture) on the collaborative editing file, a user of another mobile device (a third mobile device) can add a text description besides a picture to describe the picture. After the mobile devices finish editing and all the mobile devices close the collaborative editing mode, the control module 116 deletes the files stored in the storage unit.

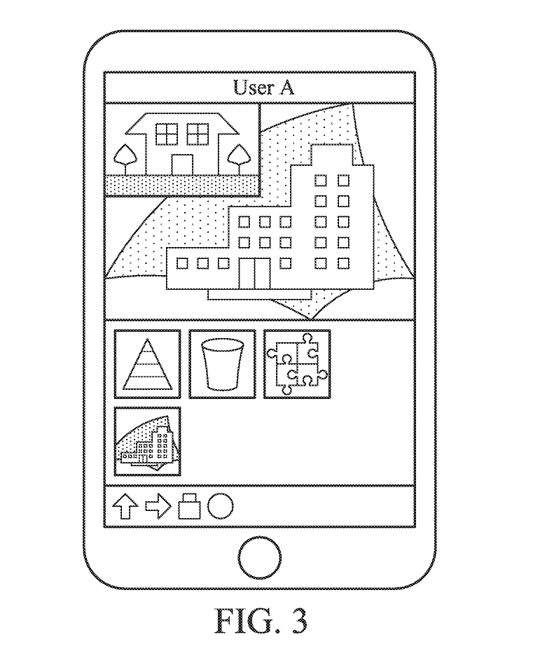

FIG. 3 shows a display image configuration of a specified mobile device of a plurality of mobile devices when the electronic device 100 is sharing files according to an embodiment of the invention. The embedded processing unit 104 may transmit the display image to the mobile device 102 by a wireless module, and the file processing module 120 may further generate a graphical user interface according to the display image on the mobile device 102. The graphical user interface comprises a plurality of display regions corresponding to the electronic device and one or more of the mobile devices. For example, an upper part shows the display image of the display unit of the electronic device 100, and a lower part shows a display image corresponding to the mobile device 102.

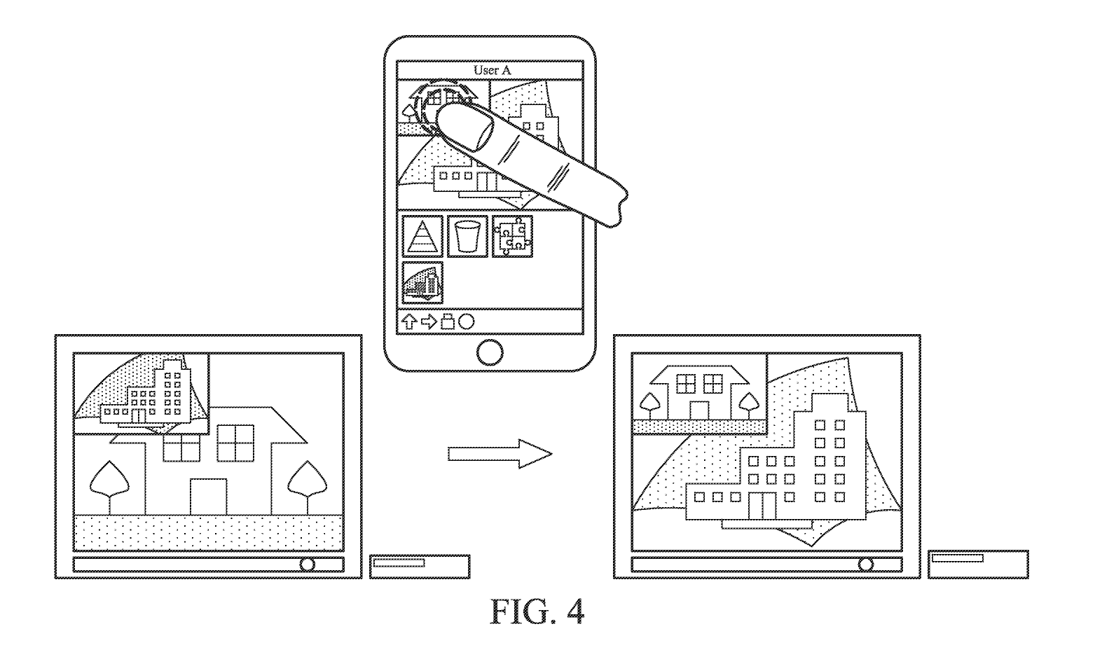

In another embodiment as shown in FIG. 4, the upper part shows a big picture and a small picture, wherein the user of the mobile device 102 can switch the pictures by double tap, triple tap . . . and so on. Further, when the mobile device 102 switches the pictures via the user interface, the mobile device 102 also transmits a packet which includes a switch signal (as an editing command) to the electronic device 100 to let the electronic device 100 switch the pictures synchronously.

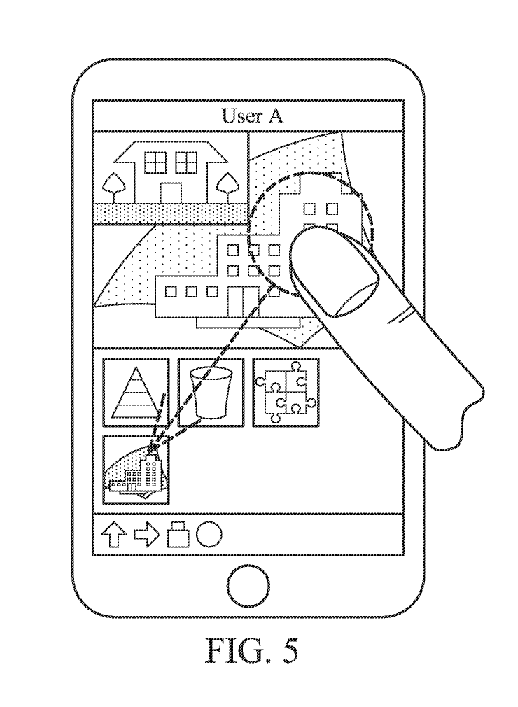

In another embodiment, the graphical user interface which is generated by the file processing module 120 comprises a plurality of display regions, wherein each display region corresponding to the electronic device and one of the mobile devices, respectively. The user interface provides a touch gesture movement detection, which is capable of determining the display regions corresponding to a start point and an end point of a gesture, for generating an editing command transmitting the corresponding file of a start display region to the corresponding device of an end display region. As shown in FIG. 5, the user of the mobile device 102 may use fingers to drag a file from the upper part of the touch screen of the mobile device 102 to the lower part in order to generate a packet which includes control signals (as editing commands) and transmit the packet to the electronic device 100 so as to download the file from the electronic device 100 to the mobile device 102. In one embodiment, the user of the mobile device 102 may drag a file from the lower part to the upper part in order to generate a packet which includes control signals and upload the packet to the electronic device to transmit the file from the mobile device 102 to the electronic device 100.

In one embodiment, the electronic device 100 may decode the packets transmitted by the mobile device 102 to obtain an editing command, and provide the following operations such as addition, deletion, revision, and searching of text, picture, and data accordingly. For example, the user of the mobile device 102 may drag a picture from the lower part of its screen to the upper part to add a picture to the collaborative editing file from the mobile device 102. For example, the user of the mobile device 102 may drag a selected text from the lower part of its screen to the upper part to add a text description to the collaborative editing file.

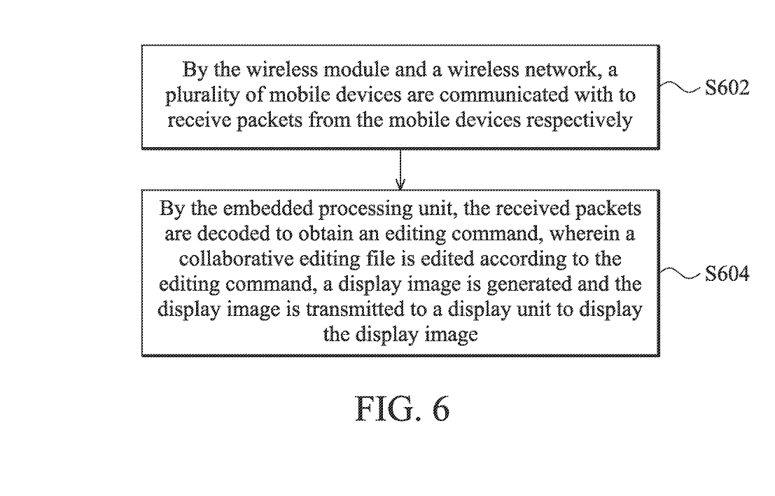

FIG. 6 shows a flow chart of a method for collaborative editing by a plurality of mobile devices according to one embodiment of the invention, and the method is suitable for an electronic device which includes an embedded processing unit and a wireless module.

To begin, by the wireless module and a wireless network, a plurality of mobile devices are communicated with to receive packets therefrom, respectively (Step S602).

Then, by the embedded processing unit, the received packets are decoded to obtain an editing command, wherein a collaborative editing file is edited according to the editing command, a display image is generated and the display image is transmitted to a display unit to display the display image (Step S604).

The function of the electronic device 100 which includes the embedded processing unit is the same with the paragraph recited above. Therefore, the function of the electronic device 100 is not described here again.

Further, the method of the invention further includes decoding the received packets from a first mobile device of the mobile devices to obtain a first file, and using the first file as the collaborative editing file, and decoding the received packets from a second mobile of the mobile devices to obtain a second file, and editing the second file and the collaborative editing file according to a editing command.

Further, the method of the invention further includes transmitting the display image to a specified mobile device of the mobile devices to display the display image, and the specified mobile device includes a graphical user interface used for displaying according to the display image. The interface further includes a plurality of display regions used for displaying the display image from the electronic device and file image of the specified mobile device, respectively; and each display region corresponds to the electronic device and one of the mobile devices, respectively. The interface further provides a touch gesture movement detection, which is capable of determining the display regions corresponding to a start point and an end point of a gesture, for generating an editing command transmitting the corresponding file of a start display region to the corresponding device of an end display region.

Therefore, the above-described embodiments of the present invention can improve the efficiency of collaborative sharing, editing, and file managing in group discussions. The electronic device and projector of the invention is capable of providing an efficient way for file editing by a plurality of users of mobile devices. Also, the method of the invention can be implemented by an electronic device with an embedded processing unit rather than a computer system.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that and aspect disclosed herein may be implemented independently of any other aspects and that two or more of these aspects may be combined in various ways.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. An electronic device for collaborative editing by a plurality of mobile devices, comprising:
a wireless module, communicating with a plurality of mobile devices via a wireless network to receive packets from the mobile devices respectively; and
an embedded processing unit, decoding the received packets to obtain an editing command for a collaborative editing file, editing the collaborative editing file and generating an display image according to the editing command, and transmitting the display image to a display unit to display the display image.

2. The electronic device as claimed in claim 1, wherein the display unit is a projection unit to project a projection image according to the display image.

3. The electronic device as claimed in claim 1, wherein the embedded processing unit further decodes the received packets from a first mobile device of the mobile devices to obtain a first file and uses the first file as the collaborative editing file.

4. The electronic device as claimed in claim 1, wherein the embedded processing unit further decodes the received packets from a second mobile device of the mobile devices to obtain a second file and edits the second file and the collaborative editing file according to an editing command.

5. The electronic device as claimed in claim 1, wherein the embedded processing unit further decodes the received packets from the mobile devices to obtain a plurality of sharing files and generates the display image according to the number of the sharing files.

6. The electronic device as claimed in claim 1, wherein the embedded processing unit provides one of the following operations, split screen arrangement, transmission, displaying, addition, deletion, revision and searching, for collaborative editing the collaborative editing file.

7. The electronic device as claimed in claim 1, wherein the embedded processing unit further transmits the display image to a specified mobile device of the mobile devices to display a display image for collaborative editing on the display screen of the specified mobile device, and the specified mobile device further provides a graphical user interface for collaborative editing according to the display image.

8. The electronic device as claimed in claim 1, wherein the embedded processing unit further stores the collaborative editing file into a storage unit.

9. The electronic device as claimed in claim 7, wherein the user interface of the specified mobile device further consists of a plurality of display regions to display the display image of the electronic device and a display image of the specified mobile device respectively.

10. The electronic device as claimed in claim 9, wherein each display region of the user interface corresponds to the electronic device and one of the mobile devices respectively, and the user interface further provides a touch gesture movement detection, which is capable of determining the display regions corresponding to a start point and an end point of a gesture, for generating an editing command transmitting the corresponding file of a start display region to the corresponding device of an end display region.

11. The electronic device as claimed in claim 1, wherein the electronic device further comprises a graphic processing unit which is electrically coupled to the embedded processing unit to assist the embedded processing unit to generate the display image and transmit the display image to the display unit.

12. A method for collaborative editing by a plurality of mobile devices, wherein the method is suitable for an electronic device comprising an embedded processing unit and a wireless module, the method comprising:
by the wireless module and a wireless network, communicating with a plurality of mobile devices to receive packets from the mobile devices, respectively; and
by the embedded processing unit, decoding the received packets to obtain an editing command for a collaborative editing file, editing the collaborative editing file and generating a display image according the editing command, and transmitting the display image to a display unit to display the display image.

13. The method as claimed in claim 12, wherein the display unit is a projection unit, and the step of displaying the display image is via projecting the display image by the projection unit.

14. The method as claimed in claim 12, further comprising decoding the received packets from a first mobile device of the mobile devices to obtain a first file and using the first file as the collaborative editing file.

15. The method as claimed in claim 14, further comprising decoding the received packets from a second mobile device of the mobile devices to obtain a second file and editing the second file and the collaborative editing file according to an editing command.

16. The method as claimed in claim 12, further comprising decoding the received packets from the mobile devices to obtain sharing files and generate the display image of the display unit according to the number of the sharing files.

17. The method as claimed in claim 12, wherein the editing command could be addition, deletion, revision and searching, for collaborative editing the collaborative editing file.

18. The method as claimed in claim 12, further comprising transmitting the display image to a specified mobile device of the mobile devices to display the display image for collaborative editing on the display screen of the specified mobile device, wherein the specified mobile device further provides a graphical user interface for collaborative editing according to the display image.

19. The method as claimed in claim 18, wherein the user interface of the specified mobile device further comprises a plurality of display regions to display the display image of the electronic device and a display image of the specified mobile device, respectively.

20. The method as claimed in claim 19, wherein each display region corresponds to the electronic device and one of the mobile devices, respectively, and the interface further provides a touch gesture movement detection, which is capable of determining the display regions corresponding to a start point and an end point of a gesture, for generating an editing command transmitting the corresponding file of a start display region to the corresponding device of an end display region.
